(19) United States
(12) Patent Application Publication
(10) Pub. No.: US 2018/0286347 A1
(43) Pub. Date: Oct. 4, 2018

(54) REMOTE AND COMPARATIVE DISPLAY OF THE GRAPHIC ART WITH COLOR ACCURACY SIMULATION IN THE WEB BROWSER

(71) Applicant: Tesseract Dev Sp. z o.o., Lublin (PL)

(72) Inventors: Tomasz DRAZEK, Krakow (PL); Richard Jason LA FRAMBOISE, Canton, MI (US); Swapan CHAUDHURI, Warszawa (PL)

(73) Assignee: Tesseract Dev Sp. z o.o., Lublin (PL)

(21) Appl. No.: 15/997,123

(22) Filed: Jun. 4, 2018

Related U.S. Application Data
(63) Continuation of application No. 15/419,995, filed on Jan. 30, 2017.

(51) Int. Cl. G09G 5/02; G09G 5/00

(52) U.S. Cl. CPC G09G 5/02; G09G 2370/02; G09G 2340/06; G09G 5/005

(57) ABSTRACT

Embodiments of the present invention define a Soft Proofing System (SPS) that optimizes the usage of standards and common technologies, without relying on proprietary technologies, to enable the use of a pure web browser environment, without the need for any additional software installation to work together with a server-side application to control and verify accuracy of reception and establish mutual communication in the approval process. This may create an opportunity for large scale, CMS driven, publishing systems, to provide an accurate, distributed, optimized and highly productive collaborative environment to accomplish fast, up to the minute delivery of digital assets to be output to multiple mediums (print and digital formats).

### CROSS-REFERENCE TO RELATED APPLICATIONS

This application is a continuation of co-pending U.S. application Ser. No. 15/419,995 filed Jan. 30, 2017 that claims the benefit of and is a non-provisional of co-pending U.S. Provisional Application Ser. No. 62/288,089 filed on Jan. 28, 2016, which is hereby expressly incorporated by reference in its entirety for all purposes.

### BACKGROUND OF THE DISCLOSURE

The present invention generally relates to graphic art industry and, but not by way of limitation, to a combination of new techniques and tools to support the exchange of information and manage mutual communication in the graphic arts industry.

The color accuracy simulation is often referred to in the publishing industry as the “proofing” process. The system emulates natural color reproduction of the graphic art, based on measurements sampled out of the real environment—using information about the known behavior of the color reproduction in the proofing system to provide the appropriate color conversion reproducing the proper colors and shapes in the “proof’. The process can be widely used for creating one or more copies of the proof, which allows the customer, or printer (or any other person responsible for reproduction quality), to view a sample and verify if the material matches the desired requirements, including verification of: spelling, positioning, size and color reproduction of elements, images and color quality.

In the printing industry it is often required to have an accurate sample of the item to be reproduced in an accurate format that can be approved by the customer and used by the press operators as an authoritative reference for the final appearance of the mass produced product. This is often referred to as a “contract proof.” Over the years, contract proofs have been created using various physical means. The ability to view color on a computer monitor opened the possibility of producing contract proofs in a “virtual” or “soft” format—a “soft proof” A “soft proof’ permits the user to inspect a proof of a printed page in a simple and inexpensive manner.

Advantages of using soft proofs for the contract proofs may include: the elimination of expensive physical systems and consumable materials required to create physical contract proofs; a reduction, sometimes significant, in the amount of human resources required to create and distribute proofs; and elimination of the need to transport physical proofs; amongst others things. Challenges may include: the ability to create color accurate soft proofs; the ability to track and manage virtual distribution of soft proofs, including changes related to file size and responsiveness of viewing systems; and the ability to record and verify the acceptance of soft proofs.

Soft proofing in the publishing industry has been a technical reality since the 1990's, however, most applications currently used for soft proofing rely on proprietary software installed in the client environment. According to a thesis published by Yang (Trends in soft proofing utilized as contract proofs in commercial lithographic printing) “[T]he introduction of Soft Proofing Systems-with the ability to quickly produce proofs at each step in the color reproduction process for a lower cost than conventional proofs—has been cited as a factor in changing the economies of this market.” It should be noted that the “Conventional proofs” here refers to physical proofs created using various means to create content and color accurate representations (contract proofs) of material to be mass reproduced—usually with various printing processes.

Currently, according to the Yang's thesis, although the general technology to create color accurate soft proofs has been available for decades, and was expected to be adopted rapidly throughout the industry, the majority of all color and content accurate proofs are still produced using a consumable's dependent process (hard proofs)—primarily through the use of color calibrated ink-jet plotters. Specifically, studies (Primir, Dynamics and Trends in Color Proofing 2005-2010) show that, in 2005 only 2% of all proofs were presented as soft proofs. The same study predicted that the industry was physiologically and economically ready to adopt the soft proof as final color accurate proofs, and there would be an exponential increase in adoption (2%-3% per year), starting with an 8% increase in use by 2008, to a total of 9% of all proofs being presented as “contract soft proofs.”

Research done by Yang, however, shows that even though there are significant savings in cost, as well as reduction of production schedules, the exponential move to soft proofing has not yet occurred. By 2013 (the date of the study) it was determined that only 4% of proofs were being presented as contract soft proofs. Also, during this time, the use of soft proofing in general (including for non-contract, not color accurate proofing) had dropped from 11% in 2005 to 5.9% in 2013. These statistics seem to bely other data that states: “[A] significant increase from 52% to 81% in acceptability of color managed soft contract proofs is reported in the present study.” Also, it has been noted in this same study that the use of color accurate, contract proofs generated using ink-jet printers (consumable based, “non-halftone hard copy proofs”) had increased, representing 76% of all proofs, or 82% of contract proofs.

While the ability and the business argument for contract soft proofing is clear and convincing, the methods remain proprietary, cumbersome from an IT and an end-user perspective, and demanding on bandwidth and processing resources. For this reason, even though acceptance and expectation of a shift to contract soft proofing has grown significantly, color managed ink-jet hard proofing is dominating the market.

### BRIEF DESCRIPTION OF THE DRAWINGS

The present disclosure is described in conjunction with the appended figures:

FIG. 1 illustrates a schematic diagram of an example of a typical creative collaboration environment.

FIG. 2 depicts an exemplary block diagram of a system architecture and its major components.

FIG. 3 illustrates an exemplary embodiment of a network delivery of the application.

FIG. 4 illustrates a schematic diagram of a graphic art decomposition used for improving speed and optimizing in-browser usage.

FIG. 5 illustrates a schematic diagram of a process for optimization, load balancing and cache pre-population of batch jobs.

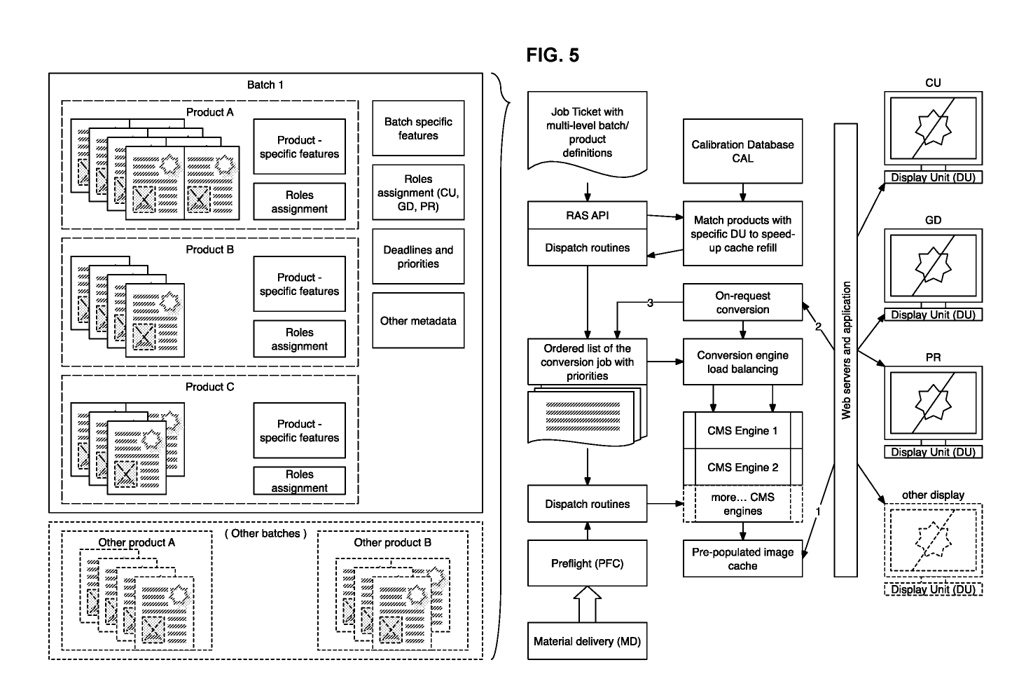

FIG. 6 illustrates a comparative document state view.

FIG. 7 illustrates a schematic diagram of a remote approval with use of QR code readers on mobile device.

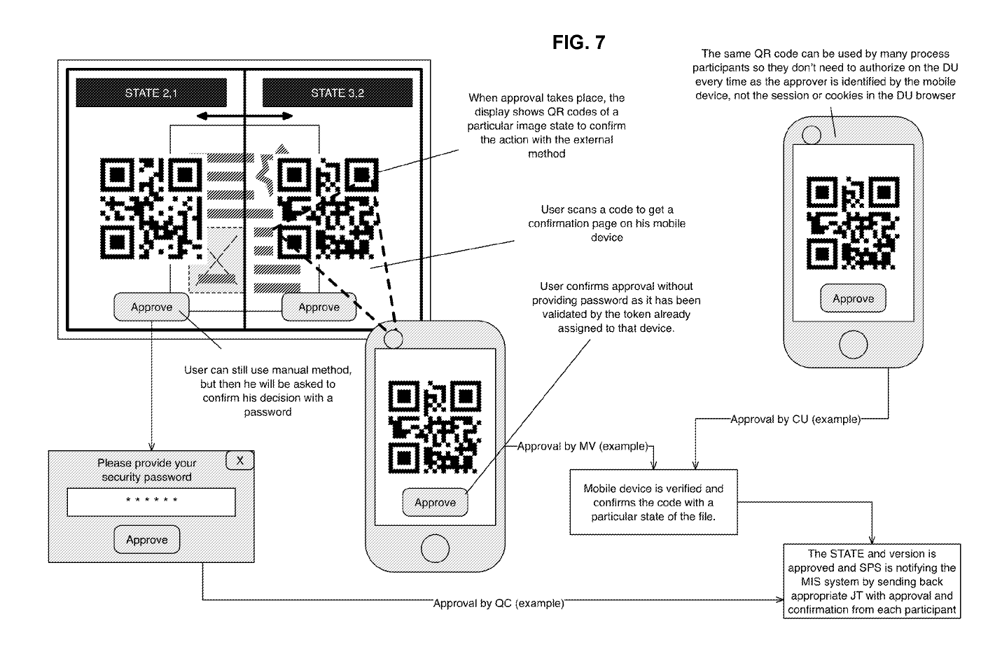

FIG. 8 illustrates a schematic diagram of an in-browser color space conversion.

FIG. 9 illustrates an exemplary embodiment of a display unit calibration for high-end and common applications.

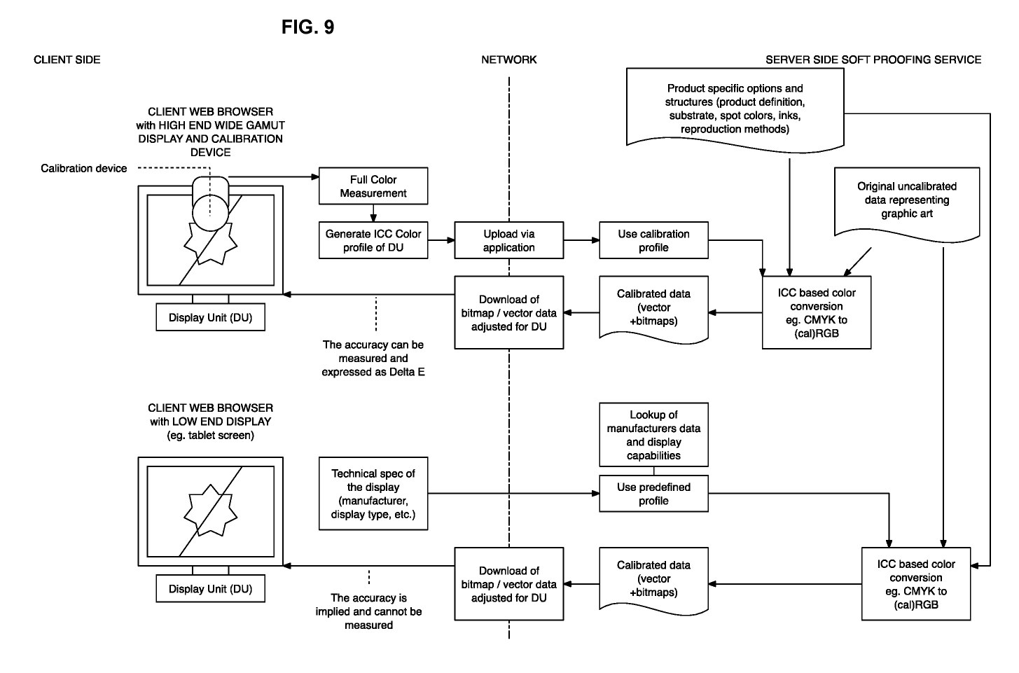

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment(s) of the disclosure. It should be understood that various changes may be made in the function and arrangement of elements without departing from the spirit and scope of the invention as set forth in the appended claims.

### Definitions

As used in this disclosure, “API—Application Programming Interface” is a set of routines, protocols, and tools for building software applications. An API expresses a software component in terms of its operations, inputs, outputs, and underlying types.

As used in this disclosure, “cloud computing”, also known as on-demand computing, is a type of internet-based computing, where shared resources and information are provided to computers and other devices on-demand.

As used in this disclosure, the “canvas element” is part of HTML5 and allows for dynamic, scriptable rendering of 2D shapes and bitmap images. It is a low level, procedural model that updates a bitmap and does not have a built-in scene graph.

As used in this disclosure, “ECMAScript” is a trademarked scripting language specification standardized by ECMA International in ECMA-262 and ISO/IEC 16262. Well—known implementations of the language, such as JavaScript, JScript and ActionScript are widely used for client-side scripting on the Web.

As used in this disclosure, in color reproduction, including computer graphics and photography, the gamut is a certain complete subset of colors from the LAB color space, which can be accurately represented in a given circumstance, such as within a given color space or by a certain output device.

As used in this disclosure, A white point IS a set of tristimulus values or chromaticity coordinates that serve to define the color “white” in image capture, encoding, or reproduction.

As used in this disclosure, the web page is a collection of HTML files together with ECMA scripts (JavaScript), images fonts, stylesheets.

As used in this disclosure, “WebSocket” is a protocol providing full-duplex communication channels over a single TCP connection. The WebSocket protocol was standardized by the IETF as RFC 6455 in 2011, and the WebSocket API in Web IDL is being standardized by the W3C.

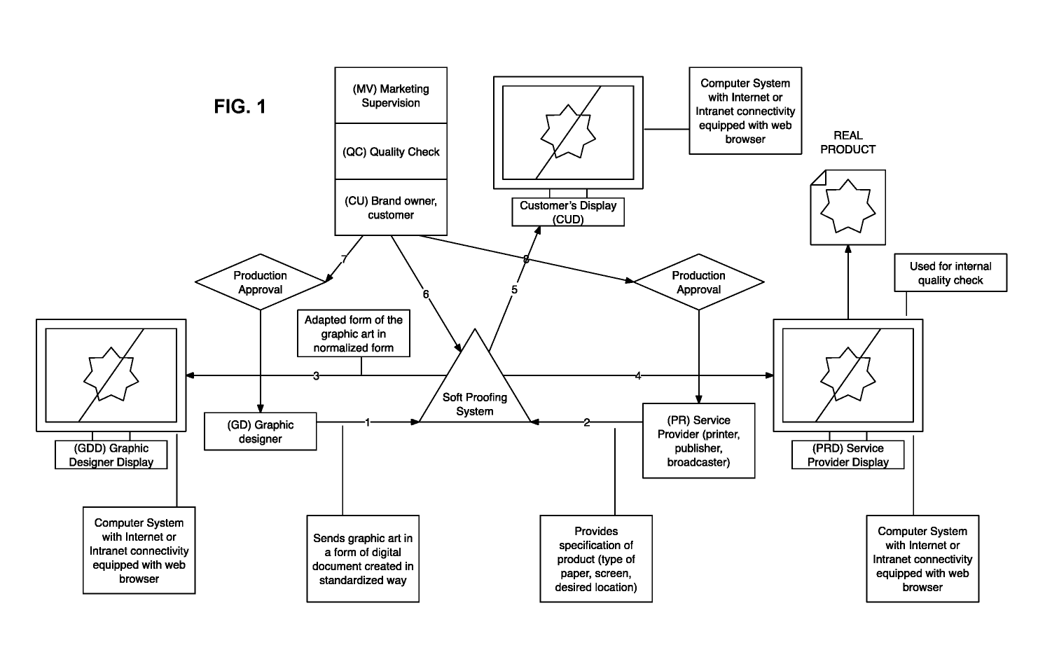

Referring first to FIG. 1, a typical creative collaboration environment is shown. The common way of working is; the service provider (PR), which could be any printing, publishing, packaging, broadcasting or any media company, delivers a product with certain technical conditions. This may include the method by which the digital form of the graphic art is processed and then prepared for release in its final form (which could be printed paper, packaging, booklet, catalogue, magazine or screen display). These technical conditions may affect the method by which the digital document is interpreted to its rasterized form (the final product's graphic art is converted into a pixel-driven rasterized form) and the way the product's colors are affected by this method (display versus print reproduction), surface, and lighting conditions. In most cases the graphic designer responsible for creation (GD) uses their own digital equipment (GDD) to ship digital material to the centralized system (SPS) via an electronic transmission (1). The Soft Proofing System uses data from service provider (PR) to get details about the method of production and the way this will affect the reproduction of the product (2).

Using information captured with measurements and any other input from the PR system, the data can be adapted to these conditions, to emulate the behavior of the elements affecting the final product. This enables the ‘Soft Proofing System’ to send back (3) the modified form of graphic art showing all affected aspects and artifacts. This scenario enables the GD verifying it against their creative and technical requirements and desires. Using the same process, the product simulation can be displayed on the Customer's display (CUD) (using path 5). The primary goal for the Soft Proofing System (SPS) is, with the accepted limited capabilities of the web browser, to reproduce all aspects of production specific issues and keep high color accuracy on the three (or more) displays (PRD, GDD, CUD). To achieve this, the SPS requires details about the color reproduction on each of these displays (defined by specific measurements, or calibration processes), as well as confirming the accuracy of the color reproduction. If the displays are confirmed to be “in sync” and show the same image interpretation of the graphic art, the communication and approval process can take place. We define approval as the ability to authenticate and verify the presence of a particular participant of the process and confirm the decisions made (for example a release to production). To better understand that process, Error! Reference source not found. shows three decision makers on the customer/consumer side, who are responsible for the final product approval. However, the number of participants, and their roles may vary, depending on the organization, with each of them utilizing separate displays or sharing a single display.

The following goals can be achieved by the above-described process:
Remote use of a web browser to reproduce the product simulation, taking into consideration all limitations of the reproduction methods, including the usage of different substrates, to achieve the highest possible quality of emulation of the product features and color accuracy, without the requirement of downloading additional software.
Optimization of the resources, in use, to reduce the amount of data transferred to the client, therefore resulting in faster display and lower memory and bandwidth consumption.
Methods of comparative and collaborative work with the graphic art, making it possible to maintain displayed data synchronization, while providing the ability to refer to any version, revision or state of the graphic art, by any particular method of reproduction, artifacts and issues related to the change of production process at the service provider.
Verify and confirm the authentication of the personnel responsible for the decision making process, using various methods including double authentication with additional use of a personal mobile device.
Various methods to calibrate and confirm the measurements of the display device are within the desired normalized range to confirm the accuracy of the color reproduction, and to match the final product conditions and further reproduction process capabilities.
Use of the system in advanced applications when it is supervised by third party applications or system, via an API, to drive integration in a common publishing environment.

### System Architecture

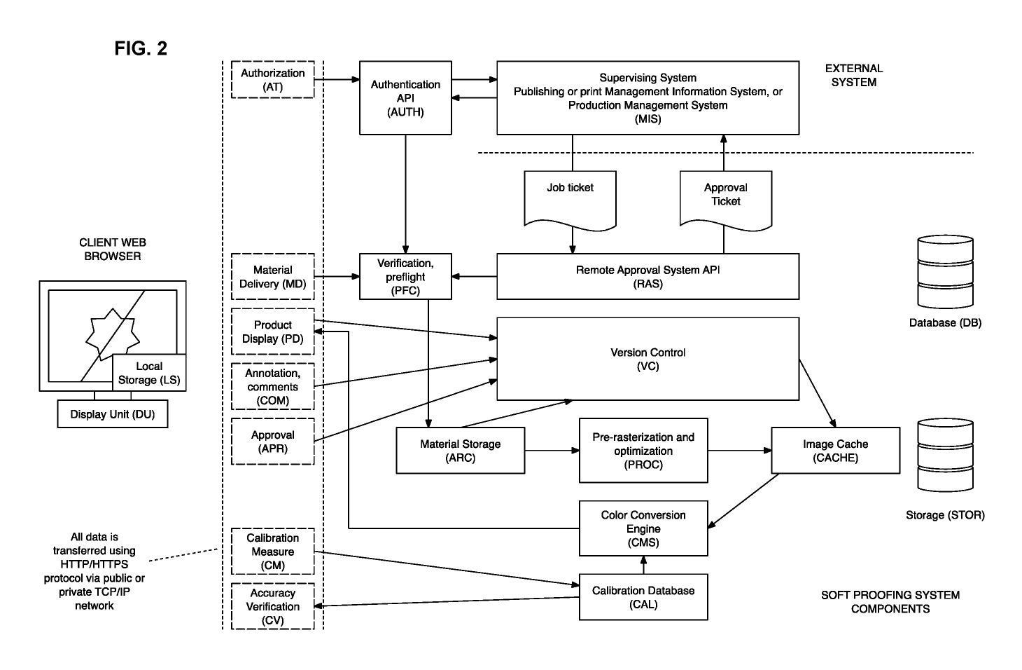

FIG. 2 shows the desired system architecture of the centralized Soft Proofing System. The system will be available as a set of micro-services, composed together to provide the complete functionality and final user experience. The software is installed on the server side and will be accessible via a TCP/IP network, so that it includes both internal applications (intranets) and remote, cloud based services over a public network. We can extract the following basic processes supported by the application:
Authentication (AT)—Validates users and prevents unauthorized access to the material as well as ensuring particular users may perform any other process within the system.
Material delivery (MD)—this process enables the submission of material in a digital format to the system, so it can be verified and adjusted to reflect final product conditions.
Product display (PD)—this process enables the transfer and updating of data, such as product definitions, states, binary images and vector graphics to the user's browser (DU) in a form where they can be interpreted and displayed to match the required accuracy without the requirement of additional software.
Communication, annotations, comments (COM)—includes all types of users' interactivity with the system, from the positioning and synching across users, to the ability to add comments, annotation or any other form of mark on the displayed graphic art to direct GD or PR or provide feedback to the QC, MV, or CU.
Approval (APR)—this process enables actions to release locks on, and exchange data with, the supervising system (MIS) in particular, the decision making process engine of the participants.
Calibration measurement (CM)—this process supports measuring and the adjusting of the elements produced with the PD component to particular DU capabilities, including color management, substrate simulation, gamut control, and ambient light conditions.
Accuracy verification (CV)—the enabling process that confirms the validity of the DU accuracy, completed by performing a quick measurement (automatic or manual procedure). This process can be invoked on a time basis or initiated by personnel.

### System Components Overview

In the following, description of each of the major components used in the system architecture of FIG. 2 is explained:
1. Display Unit (DU)—understood as the computer or similar device, equipped with a modem web browser and with a known, standardized or calibrated display.
2. Supervising System (MIS)—a system that controls a general workflow and has complete information about the product and its production parameters. Such information is collected and sent to the system as a job ticket.
3. Authentication API (AUTH)—an Application Programming Interface (API), a system component that communicates with the MIS to establish authentication and authorize users to access the result of the simulation.
4. Remote Approval System API (RAS)—an API to communicate with, and keep updates on, the job ticket information as well as the process flow. It utilizes the Version Control component to create and exchange data with the MIS.
5. Version Control (VC)—the central database of all the information required to produce the correct simulation of the final product. VC tracks information about the product features such as the type of product, surface or display, product structure (pages, chapters, sections and other content components), production parameters (the specified reproduction technology (print or screen)), ink or channels parameters, type of paper or lighting condition and associated color space and conversion profiles (ICC based) etc. The VC is also responsible for collecting revisions of the graphic art that is assigned to the product structure components and controls the verification process.
6. Verification and preflight (PFC)—responsible for the verification and adjustment, if necessary, of the material delivered by the GD and to match it with the definition of the product. The verification of the digital document is required for appropriate digital document quality and to check on basic features like page count and document geometry (sizes). This module may work in both automatic and manual processes, delivering results via an interactive interface (within the DU web application) or as API connecting with the external system (for delivering data out of a CMS or editorial system)
7. Material Storage (ARC)—the digital file storage adapted to store multiple revisions of the material delivered in a format that enables mutual association between product definition in VC and other system components.
8. Pre-rasterization and optimization (PROC)—a module of the SPS that prepares data to be efficiently stored inside the system storage (STOR) with the ability to convert the graphic art into a suitable format to be transferred and displayed on the client web browser (at DU). The PROC also optimizes the normalization of the data, avoiding any unnecessary and time consuming conversion when adapting colors to the display capabilities.
9. Image Cache (CACHE)—used to keep temporary data of the color conversion process locally on the server to optimize speed and efficiency. It may also use various resolutions to synchronize bitmap data at the appropriate quality, depending on the current zoom on the client browser.
10. Color Conversion Engine (CMS)—responsible for the image to image conversion of the source, pre-rasterized data, into the browser for color accurate and calibrated images. The same tool is used internally to measure calibration and create the correct mapping between color spaces of the original graphic art and the DU monitor.
11. Calibration Database (CAL)—keeps the information association of the particular DU to the calibration and measurement collected (set of ICC color profiles).
12. Data storage (STOR)—the storage unit keeping all files in an organized structure, enabling the VC to identify any particular material and send the correct data to the DU.
13. Database (DB)—the storage location of all structured data and relations. The system utilizes both an SQL and non-SQL based approach to optimize speed and efficiency.

### Web Based and Remote Approach

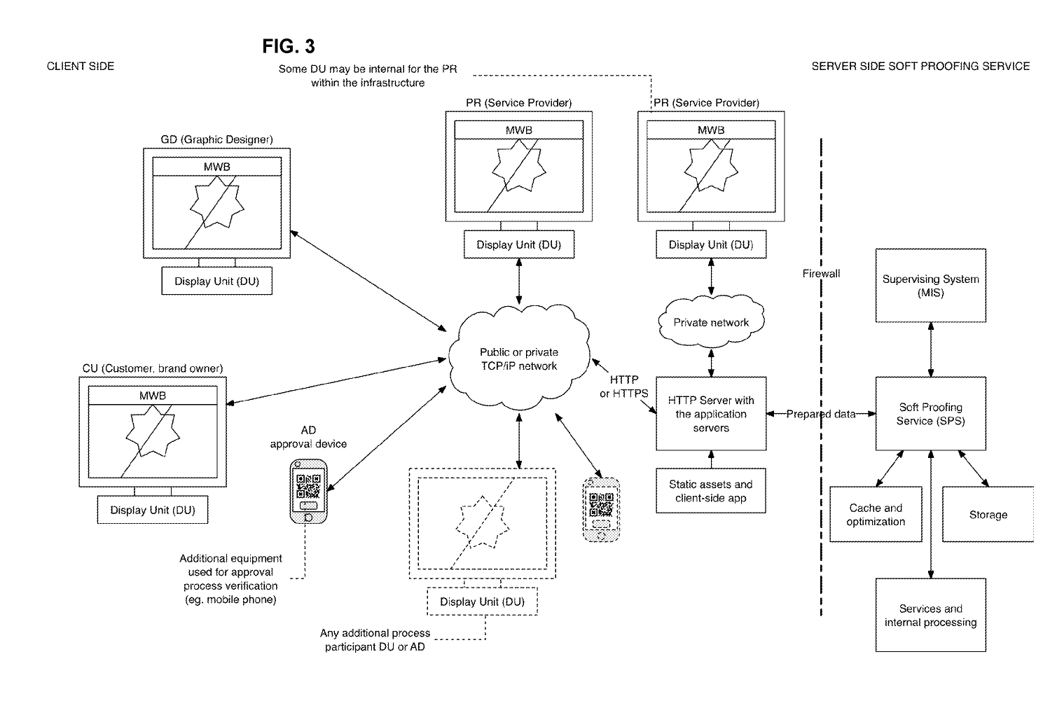

According to the embodiment shown in FIG. 2, this system is suitable to be used in remote applications and in client-server environments and utilizes data transmission methods based on TCP/IP and HTTP protocol, including secure layer (HTTPS). There is no differentiation between public networks (Internet) or private intranets in any of the methods or application usage. The core functionality of the SPS is based on the server side application that can be delivered as proprietary licensed software or as the service option (Software as a Service) and cloud delivered. An overall scheme of delivering the SPS is shown in FIG. 3.

Minimum requirement—the only tools required to support the process are a PC computer or comparable mobile device with standardized display (LED or LCD preferred) and an optional, personal mobile device (smartphone or tablets) for the approval process. The following points should be noted:
a. There is no requirement for the installation of additional software except a modern web browser (MWB). The assumption is that the modern web browser supports all current HTML5 definitions and capabilities such as local storage, html canvas object, ECMA script, and SVG, JPEG and PNG image transfer.
b. When the user accesses the http server, they download a web page with an appropriate set of scripts and its assets. The web page may keep data on the client side within the browser (LS), to remember its own state, settings and preferences as well as keep in track the current synchronization status to identify the particular display.
c. Each display (DU) must be identified to ensure the system can provide an appropriate evaluation of its capabilities including the image resolution, the number of pixels, any supported color spaces etc. The system utilizes an internal browser cookie or local storage mechanism to enable that identification.

Suggested Equipment—for the professional use of the SPS service in production delivery it is important to distinguish the following:
a. To ensure high-level color accuracy, it is recommended to implement color-calibration equipment and a wide gamut display. The system will permit the uploading of a profile that reflects the current and measured values of the display's color reproduction parameters.
b. For a common display it will be assumed that the display supports a standardized color space (most displays can perform and use Adobe RGB or sRGB) and adjust brightness and contrast parameters, under a selected white point. Such displays are suitable for viewing and proofing of the content, and are still able to get a suitable rendition of the final product form (and, in certain circumstances, these are good enough to perform the approval process, for example using a mobile device such as a tablet).

Optimization of the bandwidth usage—a key element of the proposed invention is the optimal use of the data transferred between the server and the client. The original form of the graphic art (such as a digital PDF document) usually is large, as the desired quality is high, while the same data transferred for approval process may be limited to the amount required for the correct reproduction and simulation.

The web application download—the web page with assets that has all the client-side related software is cached by the browser and directed by the HTTP server by controlling its cache. It should be noted that:
a. Only the data of the requested state (version, revision) is transferred to the client.
b. The data of the graphic art is transferred to the client's browser as a number of individual files or streams in the following order:
   i. The product structure data—including information such as page count, reproduction method, channels, inks, spot color definitions, page geometry composition and, finally, references to all graphics.
   ii. Leading vector graphic of the art—which refers to the bitmap subcomponents, with color converted to the desired DU color space.
   iii. All bitmap data, which is adjusted to the display on the DU by applying the appropriate color space conversion and separation of the color channels if needed.
   c. The data is cached on the server—so the same DU can reuse my previously generated data already on the server. This especially affects all bitmap data that has been converted, meaning there is no requirement to reprocess this data.
d. The data is so cached in the client browser to avoid data transfer if not required.
e. The part of the document composition, to achieve final simulation effect, is performed on the client system using HTML5 abilities.
f. The HTTP server that provides data for the system can additionally equipped with a geo-location load balancing mechanism that can direct that data is served from the closest node of the network.

Optimization of the graphic art—one important aspect of the present invention is the pre-rasterization and optimization process (PROC) that takes place immediately upon material submission (MD). Error! Reference source not found shows the detailed method of page decomposition that leads to the decrease of data stored and transferred to the browser, while keeping the same method of color conversion for ensuring proper reproduction on the DU display.
a. PROC reads the source document, typically a digital art graphic, that consists of vector data (line, paths, drawings, text with fonts) and raster data (bitmaps, images, photos) and creates an intermediate form that consists of the composition of pre-rasterized data (mixed vector and bitmap image).
b. The intermediate form can be converted into two objects that are readable by the browser: an SVG layer that reproduces all vector graphics, and bitmap data that is flattened so the transparencies are irrelevant.
c. Based on the data from the PRODUCT definition, the PROC can keep the graphic data as separate channels that correspond to the particular separations (e.g. ink used) for bitmap data, while the complementary data is kept in the SVG layer as additional marks, this enables the reproduction of the color accurate proof directly on the client side.
d. The bitmap data is also split into multiple segments (tiles), and each tile is kept in the storage as static files. The bitmap is also optimized to reduce the resolution (based on user settings specifying the acceptable reproduction quality), and utilizing JPEG or other compression methods. This allows for quick transfer and recreation of portions of the proof on the DU without requiring that all of the subject data be transferred and present prior to recreation.

Batch processing and load balancing—with reference to Error! Reference source not found, one of the optimization aspects required for high volume throughput of the system is the optimization of the material delivery process itself, enabling the system modules to decrease the time between delivery of the document and the first view. One of the goals of the system is to enable any user (GD, CU, PR) to quickly view dozens of graphics or versions and approve, or easily communicate and assign responsibility or actions to be taken.
a. The communication API directed by the MIS system should be able to define a batch as an organized set of products that are undergoing a similar process, this enables the upfront determination of the appropriate workflow path and, for example, detects which station will be used for approval or review.
b. Knowing the process path enables the system to pre-populate its cache and perform the appropriate color conversion for the desired devices before a user accesses the pages.
c. Batches optimize the way a user searches through, and navigates over, data to enable them to focus on the particular project.
d. The batch optimization also enables the system to directly control the priorities and perform operations such as load balancing (using more than one backend processing unit and picking the order of the pending jobs queue, thus enabling an optimal scaling up of the processing capabilities).
e. Batches can also be used for mass approval or application of changes on the processing path (e.g. the change of production parameters for numerous graphic arts that do not require any user input to the system, but rather are directed from the MIS system). The batching techniques applied are similar to search engine pre-fetch technologies, however adapted to our particular invention.
f. Due to the invention of the client side color space transformation, there is a additional benefit of the invention in the ability to support thousands of users concurrently, each utilizing a desired batching technique.
g. The system uses the data from the job ticket, in defined batches, to organize its own list of priorities for the job to be processed. When the material delivery fills the source cache of documents, it automatically changes the order of the conversion process and/or adds operations that have to be performed (based on, for example, parameter changes).

Any additional equipment such as Approval Devices (mobile phones or tablets used for QR based authentication of the approval process as described below) use the direct network connectivity over HTTP with the SPS service itself and do not require direct connectivity to the DU This process also includes future calibration devices that can be used remotely to measure and verify the accuracy of the color display, and synchronize data directly over the network with the SPS.

SPS and its web server utilize Web Socket technology to direct DU, AD (or any other devices) and to perform interactions. The system may utilize multiple conversion units, (CMS) and web servers to handle large amounts of traffic, or optimize the use of network resources, by providing a local version of the graphic art data instead of transferring it from a remote location.

### Comparative and Revision Based Collaboration

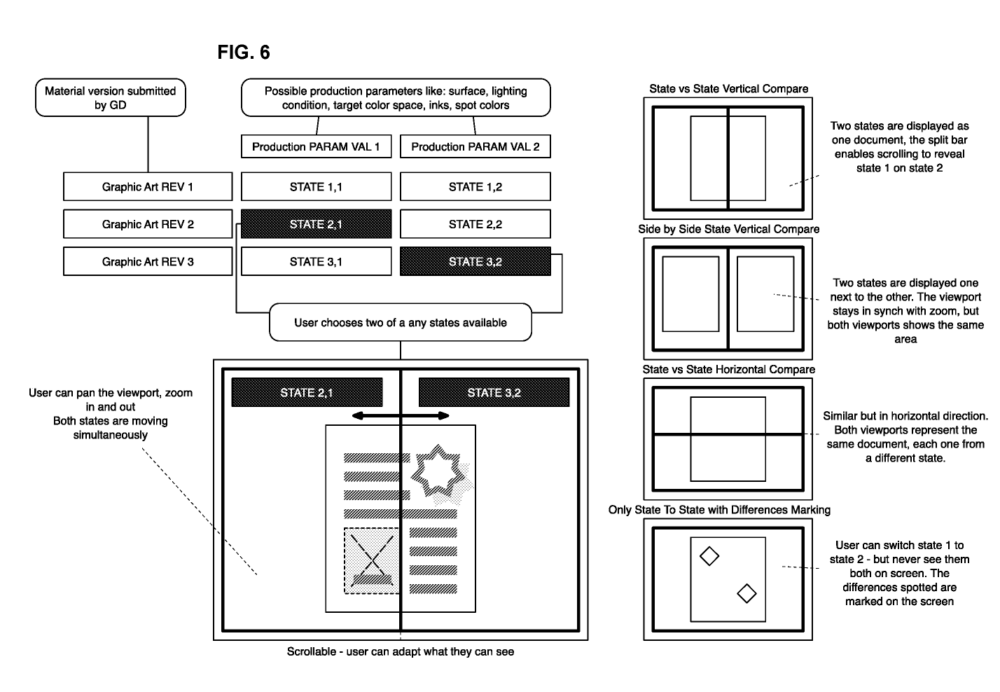

As shown in FIG. 6, the Graphic Designer (GD) can submit more than one version of the design. Each graphic art submission to the system affects the final result. The version submitted to the system becomes a revision (REV). All participants may access any version submitted (so long as they have appropriate permission) to select the desired graphic art. Production parameters are then transferred with the Job Ticket from the MIS system, and may reflect variants of the final product, by understanding the modification of the technology used, for example, the different substrates that can affect color reproduction (PARAM).

Both PARAMs and REVs are composed, and combined together to reflect the STATE of the product. The STATE of the product is displayed in a comparable way on the DU There are a number of possible variants of the graphic design comparison user interface, dependent upon the user's preferences. There are vertical and horizontal split variants, or super-imposed split pane display variations. On viewport option displays the proof or section of proof in desired with a slider acting as a divider to between the particular state; i.e. as a slider is moved left or right, up or down it divides the image showing one state on one side of the slider/divider and another state on the other, an “overlay” of two states will allow the switching on and off of states layered over each other to “flip” between one state and another. Another method shows only one state at a time, but marks/highlights all differences between selected states.

### Approval Workflow and Communication

Authentication and authorization—this process requires the user to be initially verified as a validated user for the following reasons:
a. To ensure the communication channel is secured, the application uses a secure version of the HTTP protocol with a current encryption method.
b. User utilizes a login/password or token authentication method.
c. The DU application uses session data stored within browser to identify a user signed into the system.
d. While a user is authorized to view pages, it is not necessary for them to be authorized to perform any action like approval. The permission is verified on the server with use of the AUTH module.
e. The SPS does not provide user authentication itself, it interfaces with the MIS or other platform to verify user and action (authorization).
f. The current, signed in, user can perform any action they are authorized to do so directly from the DU application including approval. The station identification with current calibration and other data like IP and geolocation date are kept in the system for the record and also are sent back to the MIS with the approval ticket.

Use of QR codes for approval on a shared DU—to avoid unnecessary sign in/sign out operations when the DU is shared across process participants (or the participant uses equipment in a different room or facility) the system provides a method to authenticate and perform actions on a mobile device by intercepting a token encrypted in a QR code.

Remote approval with encrypted QR code—as shown in the process of Error! Reference source not found:
a. The user can authorize their own mobile approval device (AD) using the mobile application internal feature. The AD keeps information about the person and we assume that this unit is to be used by only that person. The additional fingerprint verification, or any other method used on the mobile device, may be used to confirm that this particular user is performing the operation. This step should be performed once, while keeping in the system a method the user can use to un-authorize the device remotely in case of the device being lost or stolen.
b. User scans a special QR “token” that identifies the device, current calibration, content within the structure (publication, section, page). This data is sent to the SPS together with session data stored in the previous step.
c. The SPS uses its AUTH module to verify if the user signed in, using session data from the device, and with the DU identified by the scanned QR token, is authorized to perform the required action. If this is possible, the user needs only to click once, the action button to confirm approval on the mobile device.

Live refreshed image context annotations and synchronization of the display viewport:
a. the User can point at a spot or mark an area (rectangular, circular, polygonal) and enter remarks that are displayed as annotations.
b. these annotations are securely reproduced and synchronized across all the DU that display the same page.
c. an authorized user can remotely cause other users, who are viewing the same page, to show the same state—center and zoom the viewport to exactly the same location. This enables users to collectively synchronize the focus and observe the same detail of the graphic art.

Multi-level and multi-role approval—this feature enables users to focus on details of the graphic art before approval and lead the focus of the GD on delivering the expected quality material. In this way:
a. the user can choose if the remark he entered is a required “TODO”, in this case, the annotation will be treated as a special entry that is required to be fulfilled before final approval can take place.
b. the Customer (CU) can point to one or more “TODO” remarks and see their status as well modify that status, confirming the problem resolution.
c. the Designer (GD), while submitting a new version of a graphic, can point out which “TODO” it resolves.
d. only under the condition that all “TODO”s are completed can the final approval by the Customer occur.

### Color Accuracy in the Simulation

According to the embodiments of the present invention, there is a distinction between acceptable quality (suitable for proof reading) and high quality (color accurate display, ensuring users see the exact color matching), taking into account the lighting conditions and device equipment state (the color accuracy may very with the temperature, time of a day, time the display is turned on etc.,). Each of these conditions may affect the final accuracy and result in the misinterpretation of the simulated colors.

To achieve the best possible accuracy, the SPS provides: the challenge of properly displaying accurate emulation of printed/“process color” (CMYK) through a browser (RGB color space) is hampered by limitations in transfer times, accepted color and file formats, server availability (load) and other factors that require color conversion and color management to be performed at the server and large files to be created and downloaded to the proofing system each time a change is made, or specific CMYK related proofing steps (such as reading ink % or viewing individual separations) is made. Browsers will not accept (process/cache/display) CMYK or CMYK with spot (additional specialty colors used in printing) files. Sending, caching, reprocessing on the server and resending RGB color managed representations (soft proofs) appropriate for each different user (browser and monitor configuration, etc.) is unwieldy. These challenges and limitations are specifically addressed in the following embodiments of the present invention.

The utilization of pre-rasterized files as cache and optional use of SVG files as an intermediate format for vector graphics. The rasterization takes place in the native output color space (CMYK, with additional alpha channel and spot color definition for print, RGB for web, mobile and TV display). During rasterization, appropriate normalization of the output color space is performed, that is, color management is performed to create the raster image in the proper color space based on the associated ICC color profile—the ‘named output intent’.

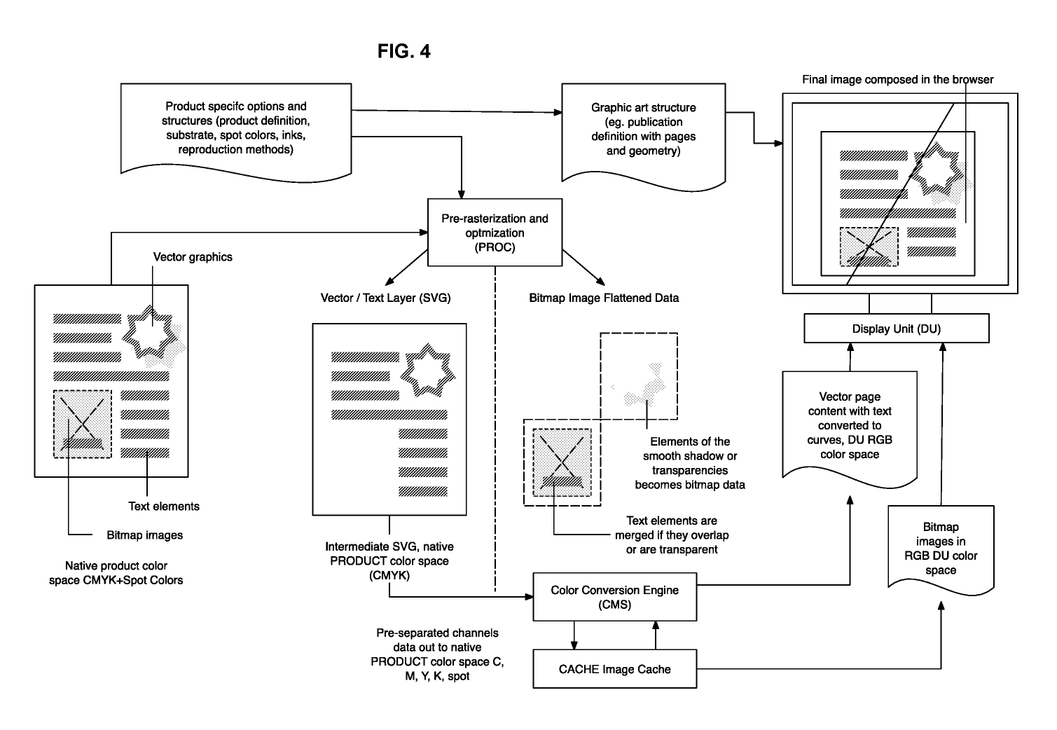

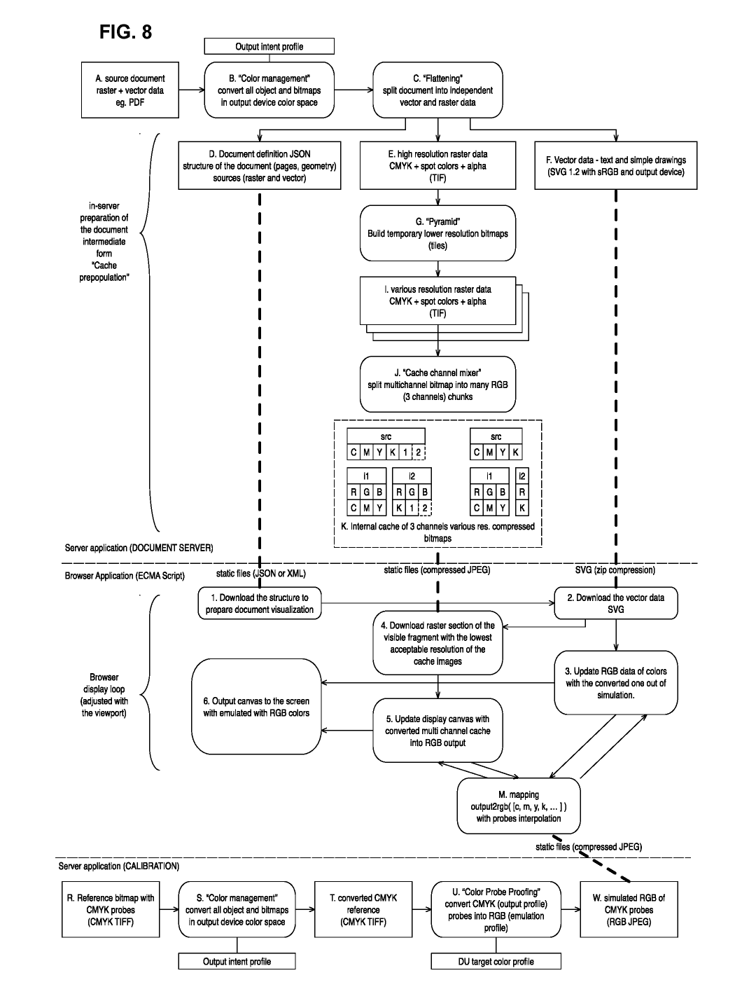

Cache preparation process—a schematic diagram of an in-browser color space conversion is shown in FIG. 8. As described further above in the “Optimization of graphic art” section and also shown in FIG. 4, the documents are pre-processed to create an optimal set of data to be transferred to the internet browser on the client's DU. As shown in Error! Reference source not found, the process starts with the regular documents (A.) conversion with color management (B.). The “Flattening process” (C.) determines how to optimize the graphic and split it into a mix of rasterized data (E.) and vectors (F.). Together with this, the process creates a description of the document structure and geometry (D.), which is the foundation for the client system to reconstruct the document on the client side. In essence, the file is “deconstructed” and broken down into component parts, based on the function of the parts and calculations for quickest transfer and reconstruction at the browser.

For vector based graphics (F.), when required, the appropriate output intent information is enclosed in the graphic element itself. This will require the use of the SVG 1.2 format (or better) which has support for unmanaged colors—with a definition of CMYK (and other channels) and an optional RGB fallback. This enables the transfer of both the RGB definition and device description, as well as the output device definition for later transformation. For bitmap data (E.), first the “Pyramid” (G.) process builds a medium range resolution bitmap appropriate for quick file transfer and proper viewing at the browser, Then the bitmap is split into tiles to further facilitate transfer and caching at the browser (I.). These tiles are kept in the target output color space (output intent) as composite bitmaps. At this point, if proofing for printed products, the files are in CMYK form and are not in a format supported by browsers or appropriate to produce color accurate proofs for viewing on RGB devices (i.e. as soft proofs).

Significant gains in transfer speed, color management (color emulation), and processing various view requests to properly represent an alternate color space using RGB, provided to multiple users on varying platforms with different browsers is achieved by an innovation that allows the color management of the soft proof elements to be performed using cached elements of the deconstructed graphic art. This transformation takes place on-the-fly, on the client system, using the browser. To achieve this, CMYK+(including spot color information if desired) data is required as the basis for the color representation. Since the browser cannot accept or understand CMYK+data files the invention to implement this procedure is as follows:
a. CMY and K data for each “tile” (FIG. 8, I.) is mapped into RGB, and gray JPEG files that act as “containers” for the data (FIG. 8, J.) rather than actual graphic elements to be displayed. To remap a CMYK tile, two corresponding JPEG files are created; one RGB JPEG file and one gray JPEG file. Each “process color” (CMYK) is stored in a specified channel of the RGB and gray files: C becomes R, M becomes G, Y becomes B, and K becomes Gray (see FIG. 8, box K.).
b. If there is a need for spot colors, the gray JPEG is replaced by a second RGB JPEG allowing for the mapping of additional colors (K.). These RGB containers hold all of the color data for the soft proof in the properly rendered “target” color space—the final “output intent”.
c. a mapping function supplied to the browser in ECMA/Java will perform the “de-mapping” and color management functions to translate the elements of the deconstructed graphic art into the proper RGB representation of the graphic art (the soft proof) using all the known environmental data of the specific browser and its hardware. This function is performed, as mentioned above, at the browser and on-the-fly, using only the portions of the graphic art required to produce the requested view and the specific knowledge of each users viewing environment, significantly increasing speed and accuracy of viewing.

The result is a set of static, cacheable files, that represent the particular state(s) of the document and pages, converted into a mid-form of the target color space as tiled bitmap and vector data. This “single source” is distributed in deconstructed form and properly rebuilt and color managed on the viewing system using its own resources rather than resorting to additional communications with, transfers from, and demands upon the resources of the server and the network.

In browser document composition and color space conversion-color conversion takes place in one centralized system so that the results will be consistent, despite local color conversion on any user system. Please note that browser support for color management is not reliable and cannot be used cross platform, for this reason the system's centralized color management engine will be used. We assume that the browser can be controlled to display the proper RGB values of the graphic elements. In some embodiments the internal color management should be turned off. The browser delivered cache graphic is to be stripped of any form of ICC profile, the browser color management will be intentionally turned off for that purpose. The client side proofing process is instigated and processed using a client side application (HTML5 and ECMA scripts) running within the browser. This begins by reading (1.) the document structures (D.)

The browser downloads the required data in the background and caches locally (2.) all vector graphics necessary for document/proof reproduction (F.) Based on the current viewport position and zoom, the client's application determines which regions and resolutions are required and only these pre-rasterized bitmaps (K.) are downloaded and cached locally using browser's internal cache (4.). The client's app, implementing an internal mapping (M.) procedure, uses reference color probes to map all of the colors from the vector graphics (3.) and downloaded, pre-determined rasterized viewport (5.) The process ends with a viewport composition of converted rasterized layer and vector graphics (6.).

Optimized client side color conversion—with a bitmap mapping, with use of centralized ICC conversion. The color conversion is based on ICC color profiles. To reduce the time required to adapt the material to a format for the browser, it is required to use Device Link ICC instead of regular LAB profiles. The CMS system will generate a device link based on a known target profile (F_{T}) (the method by which the colors are interpreted on the target system and processed) and take the DU profile (F_{D}) to make an emulation device link which is F_{T}×F_{D}⁻¹ function. To use a color profile in the browser, the system must send the profile probes to the client application running in the browser, for that purpose, the compressed bitmap is a container for probed data for the mapping function (M.).

The reference bitmap (R.) with all required CMYK (or any other simulated output intent) probes are applied to the regular color management, the same as the documents, to convert the CMYK bitmap to result in the proper output intent (T.). Next, the DU color simulation is applied to the color probes to reflect the conversion that would take place in simulated environment (D.). The result (W.) is then saved as compressed bitmap, and the client application uses it for the mapping function, downloaded as a static file. It should be understood that every pair of DU (calibrated display) and every output intent (simulated target device) are generated on demand. In addition, device link color profiles are used in order to create the required simulation probes efficiently.

Adaption to the simulation device—the system adapts colors by using a measured device profile on the particular display. These measurements, depending on the required quality (low and high end accuracy) will be delivered in two ways as shown in Error! Reference source not found. For a low quality (LQ) display (DU) the user can pick the manufacturer and model, and the system will use calibration data based on an internal lookup (the average measurements for the model or based on manufacturer data). An additional, empirical based, calibration may take place—requiring the user to perceptually confirm comparison points to adjust the gamma of the display to the emulation.

For a high quality (HQ) display (DU), the calibration can be completed using one of two methods:

i. an internal or external calibration device that creates a current ICC profile of the display (the additional software supplied with the calibration device needs to be utilized). These measurements are performed within proprietary software and utilize their own processes for that purpose. This result is a ready to use ICC profile that is attached to the DU data, stored on the server by uploading this new profile.

ii. the measurement is completed using an advanced, additional, remote calibration device (CALD) that captures patches delivered by the SPS using the browser. In this example, a color profile is generated on the server based on the sequence of measurements, controlled via a client side application.

In either cases detailed above, the system will provide a measurement accuracy factor displayed as ΔE to validate the overall system quality during color conversions. The System enforces further the HQ calibration to be redone after a specific period of time which is defined in the SPS settings. This prevents inaccurate data being used for a long period of time, as the accuracy of the calibration becomes void with time.

Confirmation of the calibration and accuracy verification—depending on the method used, the system may be configured to enforce the user to measure patches displayed on the screen before it shows the proofing content, to confirm the validation of the profile and calibration. This ensures that at a specific time (for example before approval) the system was in a verified, valid state, and guarantees that the display is accurate within a desired ΔE.

### Possible Application of the Invention

While the main purpose of this disclosure has been discussed around the needs of the graphic arts industry, the invention itself, due to its non-proprietary nature of web browser technologies, and ability to be integrated into any CMS based application, has application across a multiplicity of markets, such as for example, in package engineering, retail, and ecommerce. In package engineering field, the ability to properly soft proof the results of any composition onto different substrates (ie: plastics), currently requires complex, proprietary software. In retail, the ability to properly simulate color of products being displayed on digital sales kiosks, and digital point-of-purchase displays are very important. Further, the ability to assure color accuracy (even by a low-end standard), will greatly improve the ecommerce industry's ability, in order to resolve customer satisfaction problems resulting from the inaccurate display of colors.

Therefore, this invention has far reaching application for improvements in several market segments and industries. The potential field of application may incorporate graphic designers, printers, publishers and digital media. The described techniques enable modem web browsers, with HTML5 capabilities, to be used for remote, server controlled display of graphic art like photos, printable documents, web pages, and videos and ensures accurate color reproduction without downloading, and installing any additional software. The described process enables the end user, without deep knowledge in the field, to see a high quality simulation and interactively participate in the design collaboration and approval process for the graphic arts industry. Or to trust the color reproduction through their modem browser of the e-commerce items for the purposes of purchase or exchange.

While the principles of the disclosure have been described above in connection with specific apparatuses, it is to be clearly understood that this description is made only by way of example and not as limitation on the scope of the invention.

What is claimed is:

1. A computer implemented method for remote and comparative display of a graphic art with color accuracy simulation in a web browser, the computer implemented method comprising steps of:
receiving data corresponding to the graphic art, wherein the data comprises graphic data and complementary data;
preparing and optimizing the data for enabling transfer of the prepared and optimized data to a client system, wherein the step of preparing and optimizing data further comprises steps of reading a source document corresponding to the graphic art, the source document comprising vector data and raster data, and creating an intermediate form comprising a composition of pre-rasterized data, the pre-rasterized data comprising one or more of a mixed vector and a bitmap image;
transferring the prepared and optimized data to the client system, for enabling reconstruction of the graphic art within a web browser of the client system; and
receiving an approval for the graphic art.

2. The computer implemented method as claimed in claim 1, wherein the step of preparing and optimizing the data further comprises a step of converting the intermediate form into one or more objects, the one or more objects comprising one or more of a Scalable Vector Graphics (SVG) layer and bitmap data.

3. The computer implemented method as claimed in claim 2, wherein the graphic data is kept as separate channels corresponding to respective particular separations, within the bitmap data and the complementary data is kept in the SVG layer.

4. The computer implemented method as claimed in claim 2, wherein the bitmap data is further optimized to reduce resolution of the bitmap data on basis of a user specified reproduction quality, using a predetermined compression method.

5. The computer implemented method as claimed in claim 4, wherein the bitmap data is further split into multiple tiles, each tile of the multiple tiles being kept in storage as a corresponding static file and the multiple tiles are further kept in a target output color space as composite bitmaps.

6. The computer implemented method as claimed in claim 5, further comprising a step of mapping CMY data for each tile into a respective RGB JPEG file and K data for each tile into a respective gray JPEG file or a second RGB JPEG file.

7. The computer implemented method as claimed in claim 1, wherein the step of transferring the prepared and optimized data further comprises a step of transferring a mapping function and color probes to the client system for mapping separation data into an emulation color space, the mapping function being scripted in ECMA and/or Java.

8. The computer implemented method as claimed in claim 7, wherein the reconstruction of the graphic art within the web browser of the client system, comprises steps of:
receiving the prepared and optimized data at the client system and caching the prepared and optimized data locally within a cache of the web browser; and
using the mapping function, the color probes and HTML5 capabilities including one or more of ECMA script and canvas object, to re-compose CMYK into RGB form with color space conversion.

9. The computer implemented method as claimed in claim 1, wherein during creation of the pre-rasterized data, a raster image is created in a color space based on an associated International Color Consortium (ICC) color profile of the client system.

10. The computer implemented method as claimed in claim 1, wherein the approval is received from a mobile approval device on interception of a token, encrypted in a Quick Response (QR) code, at the mobile approval device.

11. A computer system for remote and comparative display of a graphic art with color accuracy simulation in a web browser, the computer system comprising:
a memory unit configured to store machine readable instructions;
a processor operably connected to the memory unit, the processor being configured to retrieve the machine readable instructions from the memory unit and execute the machine readable instructions, the machine readable instructions configure the processor to:
receive data corresponding to the graphic art, wherein the data comprises graphic data and complementary data;
prepare and optimize the data for enabling transfer of the prepared and optimized data to a client system, wherein for preparing and optimizing data the processor is further configured to read a source document corresponding to the graphic art, the source document comprising vector data and raster data, and create an intermediate form comprising a composition of pre-rasterized data, the pre-rasterized data comprising one or more of a mixed vector and a bitmap image;
transfer the prepared and optimized data to the client system, for enabling reconstruction of the graphic art within a web browser of the client system; and
receive an approval for the graphic art.

12. The computer system as claimed in claim 11, wherein the processor is further configured to convert the intermediate form into one or more objects, the one or more objects comprising one or more of a Scalable Vector Graphics (SVG) layer and bitmap data.

13. The computer system as claimed in claim 12, wherein the processor is further configured to keep the graphic data as separate channels corresponding to respective particular separations, within the bitmap data and keep the complementary data in the SVG layer.

14. The computer system as claimed in claim 12, wherein the processor is further configured to optimize the bitmap data, to reduce resolution of the bitmap data on basis of a user specified reproduction quality, using a predetermined compression method.

15. The computer system as claimed in claim 14, wherein the processor is further configured to split the bitmap data into multiple tiles, each tile of the multiple tiles being kept in storage as a corresponding static file and the multiple tiles are further kept in a target output color space as composite bitmaps.

16. The computer system as claimed in claim 15, wherein the processor is further configured to map CMY data for each tile into a respective RGB JPEG file and K data for each tile into a respective gray JPEG file or a second RGB JPEG file.

17. The computer system as claimed in claim 11, wherein for transferring the prepared and optimized data, the processor is further configured to transfer a mapping function and color probes to the client system for mapping separation data into an emulation color space, the mapping function being scripted in ECMA and/or Java.

18. The computer system as claimed in claim 11, wherein during creation of the pre-rasterized data, the processor is further configured to create a raster image in a color space based on an associated International Color Consortium (ICC) color profile of the client system.

19. The computer system as claimed in claim 11, wherein the processor is further configured to receive the approval from a mobile approval device, on interception of a token, encrypted in a Quick Response (QR) code, at the mobile approval device.

20. A client system for remote and comparative display of a graphic art with color accuracy simulation in a web browser, the client system configured to:
receive prepared and optimized data and cache the prepared and optimized data locally within a cache of the web browser, wherein the prepared and optimized data includes an intermediate form comprising a composition of pre-rasterized data, the pre-rasterized data comprising one or more of a mixed vector and a bitmap image, the intermediate form being created following reading of a source document corresponding to the graphic art, the source document comprising vector data and raster data;
receive a mapping function and color probes for mapping separation data into an emulation color space, the mapping function being scripted in ECMA and/or Java; and
use the mapping function, the color probes and HTML5 capabilities including one or more of ECMA script and canvas object, to re-compose CMYK into RGB form with color space conversion.
